(19) United States
(12) Patent Application Publication
(10) Pub. No.: US 2013/0055071 A1
(43) Pub. Date: Feb. 28, 2013

(54) SYSTEMS AND METHODS FOR CREATING A CUSTOMIZED WEBSITE

(71) Applicant: Carne Robert Gordon Bray, Toronto (CA)

(72) Inventor: Carne Robert Gordon Bray, Toronto (CA)

(21) Appl. No.: 13/660,302

(22) Filed: Oct. 25, 2012

Related U.S. Application Data
(63) Continuation of application No. 12/713,678, filed on Feb. 26, 2010.
(60) Provisional application No. 61/160,459, filed on Mar. 16, 2009.

(51) Int. Cl. G06F 17/00

(52) U.S. Cl. 715/234

(57) ABSTRACT

Systems and methods for creating a customized website. The system may include (a) a customization database configured to store customization data, (b) a website builder database configured to store a plurality of registered builder websites, (c) a customizable website template comprising a free-variable expression positioned within the template, wherein the template is stored in the website builder database as a registered builder website, (d) a preprocessor registry configured to register the location of the template in the website builder database, and (e) a website preprocessor operatively coupled to the preprocessor registry. The website preprocessor may be configured to (i) access the preprocessor registry to determine the location of the template, (ii) retrieve the template from the website builder database, (iii) replace the free-variable expression within the customizable website template with the customization data to create the customized website, and (iv) store the customized website in the website builder database.

### RELATED APPLICATIONS

This application is a continuation of application Ser. No. 12/713,678 filed on Feb. 26, 2010. This application also claims priority from U.S. provisional patent application No. 61/160,459, filed on Mar. 16, 2009, which is incorporated herein by reference.

### TECHNICAL FIELD

Embodiments described herein relate generally to website creation, and more specifically to systems and methods for creating a customized website.

### BACKGROUND

Traditionally, website customization has been a separate process from website creation. Customizing a website has often been accomplished by using a website builder system. Website builder systems provide tools for modifying a website. Accordingly, the inventor has recognized a need for improved systems and methods for creating a customized website.

### BRIEF DESCRIPTION OF THE DRAWINGS

For a better understanding of the example embodiments described herein, and to show more clearly how they may be carried into effect, reference will now be made, by way of example, to the accompanying drawings in which:

FIG. 1 is a block diagram of a customized website creation system for creating a customized website in one example implementation;

FIG. 2 is a schematic illustration of example customer records containing exemplary customer data as may be stored in the customer database of FIG. 1;

FIG. 3 is a schematic illustration of example customization records containing exemplary customization data as may be stored in the customization database of FIG. 1;

FIG. 4 is a schematic illustration of example website builder identification records containing exemplary website builder identification data as may be stored in the preprocessor registry of FIG. 1;

FIG. 5 is a schematic illustration of example host identification records containing exemplary host identification data as may be stored in the preprocessor registry of FIG. 1;

FIG. 6 is a schematic illustration of example template identification records containing exemplary template identification data as may be stored in the preprocessor registry of FIG. 1;

FIG. 7 is a schematic illustration of example registered builder website records containing exemplary registered builder websites data as may be stored in the website builder database of FIG. 1;

FIG. 8 is a flowchart illustrating steps of a method for creating a customized website in accordance with at least one embodiment;

FIG. 9 is an example screen shot of a blank website builder template as may be created and/or used in the exemplary customized website creation system of FIG. 1;

FIG. 10A is an example screen shot of a realtor-themed customizable website template created from the blank website builder template of FIG. 9;

FIG. 10B is an example screen shot of a resume-themed customizable website template created from the blank website builder template of FIG. 9;

FIG. 11A is an example screen shot of a business card website coupled to a website hosting service in one example implementation;

FIG. 11B is an example screen shot of a domain registrar website coupled to a website hosting service in another example implementation;

FIG. 12A is an example screen shot of a customized website as may be generated by the customized website creation system in FIG. 1 for a realtor website using customer information from the business card website in FIG. 11A; and

FIG. 12B is an example screen shot of a customized website as may be generated by the system in FIG. 1 for a resume website using customer information from the domain registrar website in FIG. 11B.

It will be appreciated that for simplicity and clarity of illustration, elements shown in the figures have not necessarily been drawn to scale. In other instances, well known methods, software modules, and elements have not been shown in detail so as not to obscure the embodiments described herein. Those of ordinary skill in the art, with the included descriptions, will be able to implement the appropriate functionality without undue experimentation. Further, where considered appropriate, reference numerals may be repeated among the figures to indicate corresponding or analogous elements.

### DETAILED DESCRIPTION

Embodiments described herein are generally directed to systems and methods for creating a customized website.

In a first broad aspect, at least one embodiment described herein is directed towards a system for creating a customized website. The system may include (a) a customization database configured to store customization data, (b) a website builder database configured to store a plurality of registered builder websites, (c) a customizable website template comprising a free-variable expression positioned within the website template, wherein the customizable website template is stored in the website builder database as a registered builder website, (d) a preprocessor registry configured to register the location of the customizable website template in the website builder database, and (e) a website preprocessor operatively coupled to the preprocessor registry. The website preprocessor may be configured to (i) access the preprocessor registry to determine the location of the customizable website template, (ii) retrieve the customizable website template from the website builder database, (iii) replace the free-variable expression within the customizable website template with the customization data to create the customized website, and (iv) store the customized website in the website builder database.

In some instances, a free-variable expression may include a delimiter concatenated to a reference name.

In some instances, the system may include a website builder application operatively coupled to the website builder database. The website builder application may be configured to modify registered builder websites.

In some instances, the website preprocessor may be configured to publish the customized website to the website hosting service.

In some instances, the customization data may be displayed when the customized website is displayed.

In some instances, the system may include a customer database configured to store customer data, wherein the customization data corresponds to customer data. In some aspects of that instance, the system may include a website hosting service operatively coupled to the customer database, wherein the website hosting service may be configured to determine customer data. In further aspects, the website preprocessor may be configured to supply an expressions list comprising the free-variable expression, to the website hosting service. The website hosting service may also be configured to determine the customization data in correspondence to the expressions list.

In another broad aspect, at least one embodiment described herein is directed towards a preprocessing system for creating a customized website. The preprocessing system may be used with (a) a customization database configured to store customization data, (b) a website builder database configured to store a plurality of registered builder websites, and (c) a customizable website template comprising a free-variable expression positioned within the website template. The customizable website template may be stored in the website builder database as a registered builder website. The preprocessing system may include a preprocessor registry configured to register the location of the customizable website template in the website builder database and a website preprocessor operatively coupled to the preprocessor registry. The website preprocessor may also be configured to (i) access the preprocessor registry to determine the location of the customizable website template, (ii) retrieve the customizable website template from the website builder database, (iii) replace the free-variable expression within the customizable website template with the customization data to create the customized website, and (iv) store the customized website in the website builder database.

In some instances, the website preprocessor may be further configured to publish the customized website to a website hosting service.

In some instances, the website preprocessor may be configured to supply an expressions list comprising the free-variable expression, to a website hosting service. In some aspects, the website hosting service may be further configured to determine the customization data in correspondence to the expressions list.

In another broad aspect, at least one embodiment described herein is directed towards a method for creating a customized website. The method may include (a) storing a customizable website template as a registered builder website within a website builder database, wherein the customizable website template comprises a free-variable expression positioned within the customizable website template, (b) registering the location of the customizable website template in a preprocessor registry, (c) determining customization data, (d) accessing the preprocessor registry to determine the location of the customizable website template, (e) retrieving the customizable website template from the website builder database, (f) replacing the free-variable expression positioned within the customizable website template with the customization data to create the customized website, and (g) storing the customized website in the website builder database.

In some instances, a free-variable expression may include a delimiter concatenated to a reference name.

In another broad aspect, at least one embodiment described herein is directed towards a method for creating a customized website. The method may include (a) providing a customizable website template in a website builder database, wherein the customizable website template comprises a free-variable expression positioned within the customizable website template, (b) determining customization data, (c) accessing a preprocessor registry to determine the location of the customizable website template, (d) retrieving the customizable website template from the website builder database, (e) replacing the free-variable expression positioned within the customizable website template with the customization data to create the customized website, and (f) storing the customized website in the website builder database.

In some instances, a free-variable expression may include a delimiter concatenated to a reference name.

In some instances, the method may include publishing the customized website to a website hosting service.

In some instances, the customization data may be displayed when the customized website is displayed.

In some instances, the customization data may be determined to correspond to customer data stored in a customer database. The method may also include determining customer data at a website hosting service, wherein the website hosting service is operatively coupled to the customer database.

In some instances, the method may include supplying an expressions list comprising the free-variable expression, to a website hosting service. In some cases, the determining of the customization data may further include determining the customization data in correspondence to the expressions list.

In another broad aspect, at least one embodiment described herein is directed towards a method for creating a customizable website template for use with a website builder application. The method may include (a) providing a website builder database configured for storing a plurality of registered builder websites, (b) creating a customizable website template using the website builder application, the customizable website template comprising a free-variable expression positioned within the customizable website template, (c) storing the customizable website template as a registered builder website within the website builder database and (d) registering the location of the customizable website template in a preprocessor registry.

In another broad aspect, at least one embodiment described herein is directed towards a preprocessing system. The preprocessing system may include (a) a preprocessor registry and (b) a website preprocessor operatively coupled to the preprocessor registry. The website preprocessor may be configured for (i) receiving a customizable website template, (ii) storing the customizable website template as a registered builder website within a website builder database, and (iii) registering the location of the customizable website template in the preprocessor registry.

A computer-readable storage medium may also be provided for storing program code. The program code may comprise instructions, when executed on a processor, implement or perform the method(s). In some implementations, the computer-readable medium may be non-transitory.

These and other aspects and features of various embodiments will be described in greater detail below.

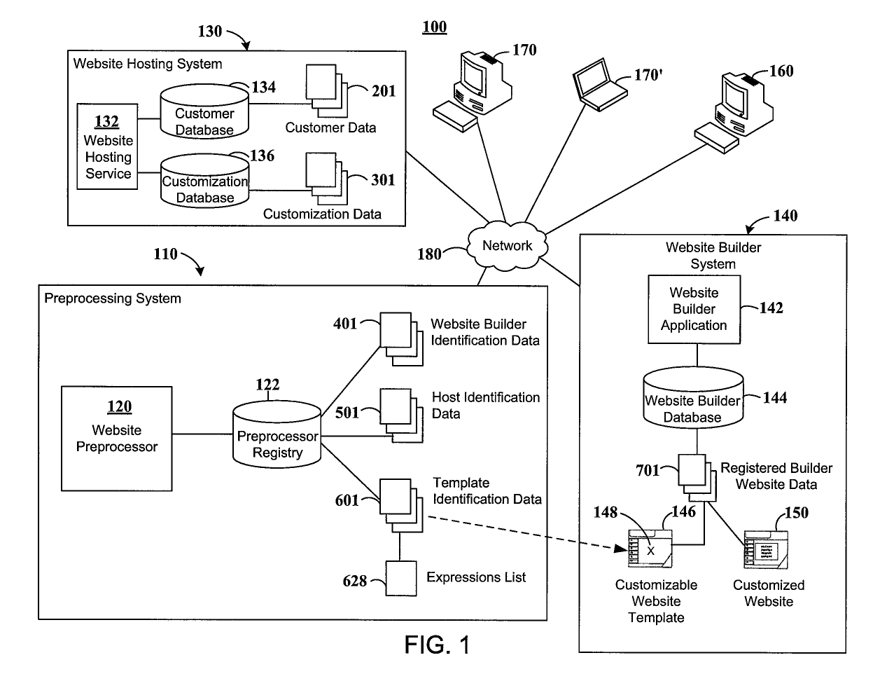

Referring first to FIG. 1, a block diagram of a customized website creation system for creating a customized website 150 in one example implementation is shown generally as 100. The illustrated embodiment of the website creation system 100 includes three subsystems or modules: a preprocessing system 110, a website hosting system 130, and a website builder system 140. The preprocessing system 110 may be configured to receive customization information (typically from website hosting system 130) and merge it with a customization website template 146 stored in the website builder system 140 to create a customized website 150. Each of the subsystems or modules 110, 130, 140 may be implemented in software and stored in memory on separate computers (not shown) or on one or more shared computers. Furthermore, the databases described below may be stored in memory on a single computer or distributed across a number of connected servers.

Website creation has historically been separated into two stages: the design of the site and the creation of content. The market has reacted to this natural separation accordingly. Designs are available as pre-built website templates that have no content and can be purchased by different site owners at a reduced cost from having to develop an original site from “scratch”. Once created, it is up to the website owner to populate the website with his or her custom content using a manual process. Tools for modifying the website may then be provided, for example, by a website builder application 142. Using such an approach, the content must still be manually added by the website owner.

Conversely, a business (such as a website hosting system 130) may contain information about its customers. Although the information may not be collected specifically for the creation of a website, the inventor has recognized that in many circumstances, this information may be sufficient to create an initial customized website. The process of building an initial customized website may therefore be simplified by utilizing the customer information to populate a website template with customized content.

System 100 facilitates the determination of customization information (based on the customer information) to be added into a customizable website template 146. The customizable website templates 146 may be created and stored by the website builder system 140 and managed using the preprocessing system 110.

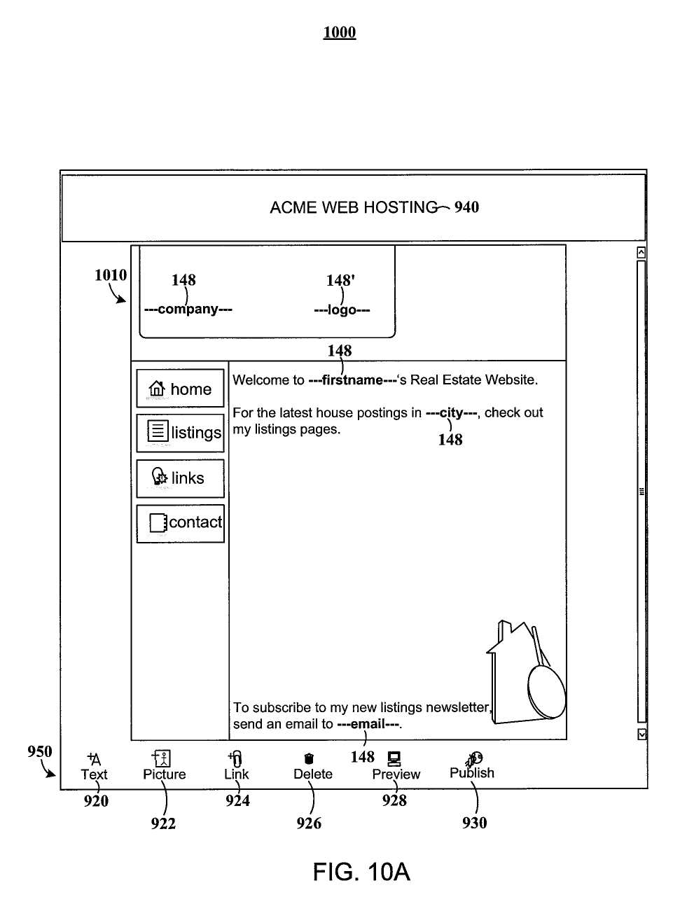

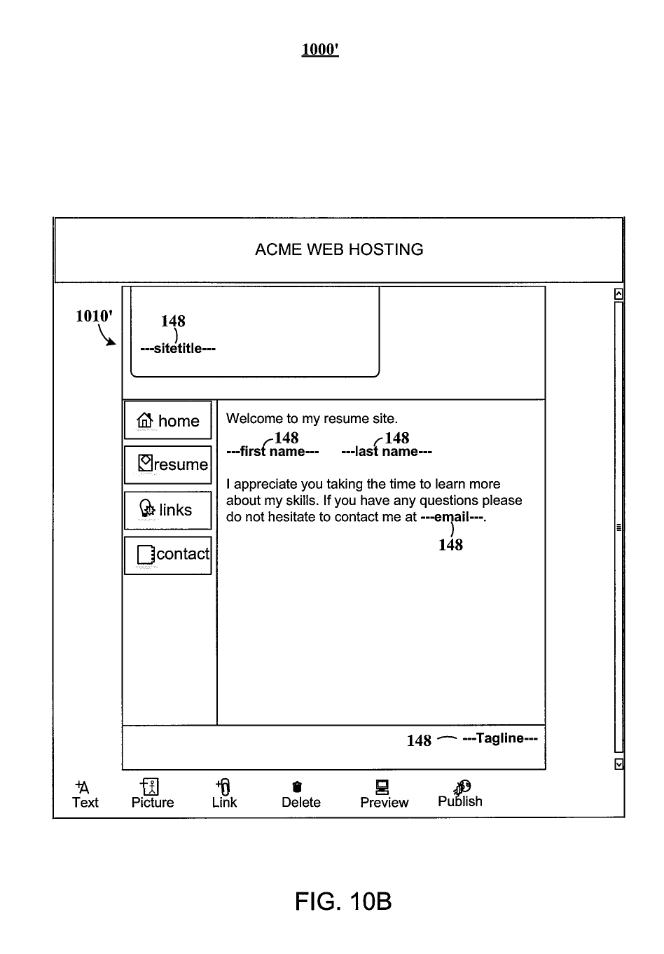

Referring briefly to FIG. 10A, illustrated therein is a customizable website template 1010. As shown in the example customizable website template 1010, incorporated within the design is a free-variable expression 148, which may ultimately be replaced with customization information from corresponding customization data 301. A free-variable expression 148 may represent a simple concept such as a name or address information for a website. In addition or in the alternative, it may represent an image, a music file or other multimedia content.

By way of example only, in FIG. 10A, the free-variable expressions illustrated in exemplary customizable website template 1010 include: ---company---, ---logo---, ---firstname---, ---city---, and ---email---. The free-variable expression 148 may represent (or be intended to be replaced by) a single word, an entire section of text, an image, or any other type of data which may be incorporated into a website. Furthermore, a free variable expression 148 may be embedded within pre-generated template text. Whole sentences (e.g, “Welcome to ---firstname---'s Real Estate Website.”) may be created incorporating a free-variable expression 148 for later replacement.

A free-variable expression 148 may be implemented in a number of different ways. The expressions are constructed such that they are easily identified by the website preprocessor 120 for future replacement. In some embodiments and as described above, a free-variable expression 148 may be comprised of a delimiter concatenated to a reference name. As used in FIG. 10A, the free-variable expressions 148 append three dashes “---” to either side of a reference name, such as “company”, “city”, or “logo”. It should be apparent that other methods and/or other delimiters may be used. The examples of free-variable expressions described within this application and depicted within the figures should not be construed as limiting.

The preprocessing system 110, through the website preprocessor 120 and the data stored in the preprocessor registry 122, conducts the transfer of information between the website hosting system 130 and the website builder system 140. In particular, the website preprocessor 120 ensures that the information in the customization data 301 stored in the customization database 136 correctly replaces each of the one or more free-variable expressions 148 positioned within the customizable website template 146. An expressions list 628 containing a list of free-variable expressions 148 may be stored within the preprocessor registry 122. The website preprocessor 120 may supply this expressions list 628 to the website hosting service 132 to aid in this determination. In particular, the expressions list 628 may enable the website hosting system 130 to match or otherwise determine the correspondence between the information from the customization data 301 with the one or more free-variable expressions 148 positioned within the customizable website template 146. The interaction between the website preprocessor 120 and the preprocessor registry 122 is further explained below.

At a high level, the customized website creation system 100 is configured to undertake the creation of customized websites 150 by implementing a number of component systems. The components may be operatively connected via a network 180. The network 180 may incorporate or otherwise be operatively coupled to different types of networks (e.g. Local Area Networks (LANs), Wide Area Networks (WANs), the Internet), and may be wired (e.g. through an Ethernet, serial or ATM connection) or wireless (e.g. through 802.11 Wireless Local Area Network (WLAN), or cellular standards), for example.

One potential benefit of system 100 may be to integrate the collection of customer data 201 for a primary purpose, such as printing business cards or registering a domain name, with the creation of a customized website 150. In some embodiments, the website hosting service 132 may integrate the process of creating and publishing a customized website 150 into its current sales process. As a result, the creation of a customized website 150 may be part of a relatively seamless flow (to the customer) that occurs during customer acquisition, instead of during a separate process. Once the customized website 150 is generated, the user/customer may continue to use the website builder application 142 to add additional text, images, and links to the customized website 150. Bringing the user into the website builder application 142 immediately with customized content preloaded may encourage the customer to become engaged. Furthermore, an initial customized website 150 is likely to keep the customer interested in editing and republishing it. As may be appreciated, an initial website 150 populated with the information in the customization data 301 will allow users to visualize their site in the initial steps, with an appropriate design and content. This may also encourage users to upgrade their services (provided, for example, by the website hosting service 130).

From a high level perspective, customized website creation system 100 may be used to create a customized website 150. The creation process may be initiated by a request to build the customized website 150 from a website hosting system 130. The website hosting service 132 may indicate to the website preprocessor 120 which customizable website template 146 to use. The website preprocessor 120 in turn accesses the preprocessor registry 122 to determine the location of the customizable website template 146. Next, the customizable website template 146 is retrieved by the website preprocessor 120. Once retrieved, the website preprocessor 120 may be configured to create the customized website 150 by incorporating information from the customization data 301 stored in the customization database 136. The customization data 301 may be provided to the website preprocessor 120 by the website hosting service 132 and the website preprocessor 120 may be configured to replace the free-variable expression 148 in the customized website template 146 with customization information stored in the customization data 301. Once complete, the customized website 150 may be stored in the website builder database 144. It may be stored as a registered builder website data 701 and may be modified further using the tools of the website builder application 142.

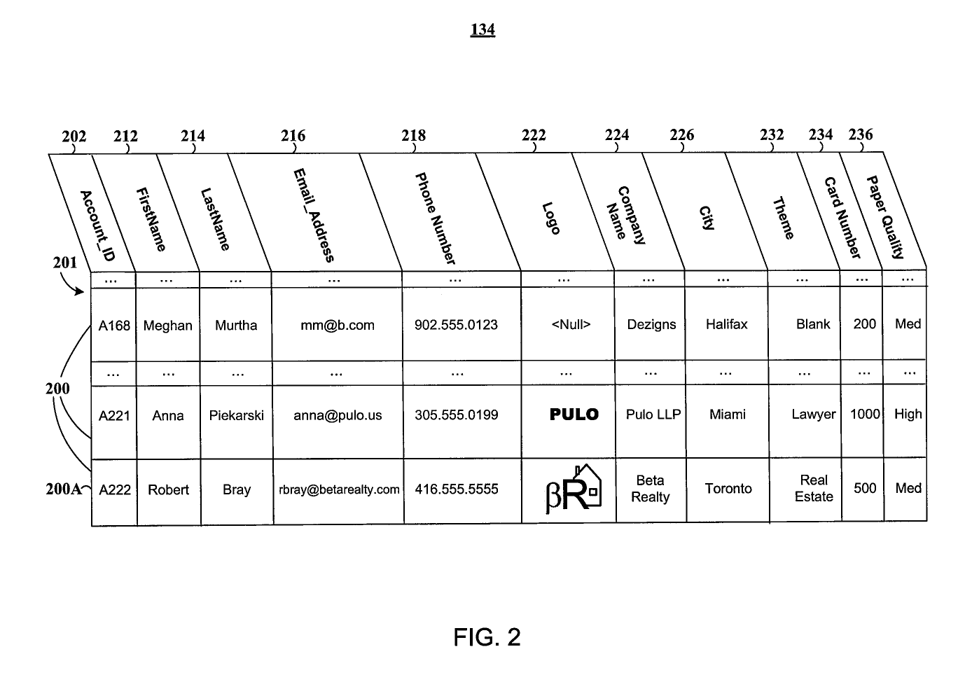

Reference will now be made to FIG. 2 through FIG. 7 which illustrate example records containing exemplary data as may be stored in the databases shown in FIG. 1. The utilization of the information stored in these databases to create a customized website 150 will be described further below. As will be appreciated by those skilled in the art, the data structures and exemplary data records 200, 300, 400, 500, 600, 700 shown in FIG. 2 to FIG. 7 are provided for exemplary purposes only and are not to be construed as limiting. Variations to the types of data stored and the organizational structures used to store information in the system 100 are possible in alternative embodiments.

Starting with FIG. 2, depicted therein is a schematic illustration of example customer records 200 containing exemplary customer data 201 as may be stored in the customer database 134. The customer data 201 stored in the customer database 134 generally corresponds to standard customer information that would be collected by a business, for example, a website hosting system 130 capable of hosting website content. Exemplary website hosting systems 130 may include a business card website (operated by a business, printing and selling business cards) and a domain name registrar (in the business of registering domain names). Each customer record 200 may correspond to a different customer. The customer data 201 may include a unique account identifier 202 (such as a unique number or alphanumeric string produced by the database). This account identifier 202 may form the link for other electronic records across the system.

The customer data 201 stored in the customer record 200 will vary based on the nature of the business provided by, and corresponding to, the nature of the customers of the website hosting system 130. Different website hosting systems 130 will collect different information from and/or about their customers. Furthermore, in some instances a new customer record 200 may be created each time a customer makes a purchase. For example, FIG. 2 illustrates a schematic illustration of the customer data 201 from a business card printer as will be discussed later. Exemplary data 201 for a business card type of application may, for example, comprise: a first name 212, a last name 214, an email address 216, and a phone number 218. It may also include, for example, business related information such as a company name 224 and an address, which may include separate fields for city 226 and postal code (not shown). In some embodiments, non-textual elements may also be stored, such as a business logo 222 or other media objects. Finally, the customer data 201 may further include specific information related to the website hosting system 130, for example, a theme of the business card 232, the number of business cards to print 234, and the quality of the card paper 236. As will be appreciated by those skilled in the art, variations to the type of data and organizational structures used to store the customer data 201 in the customer database 134 are possible and the examples described above are for illustration purposes only.

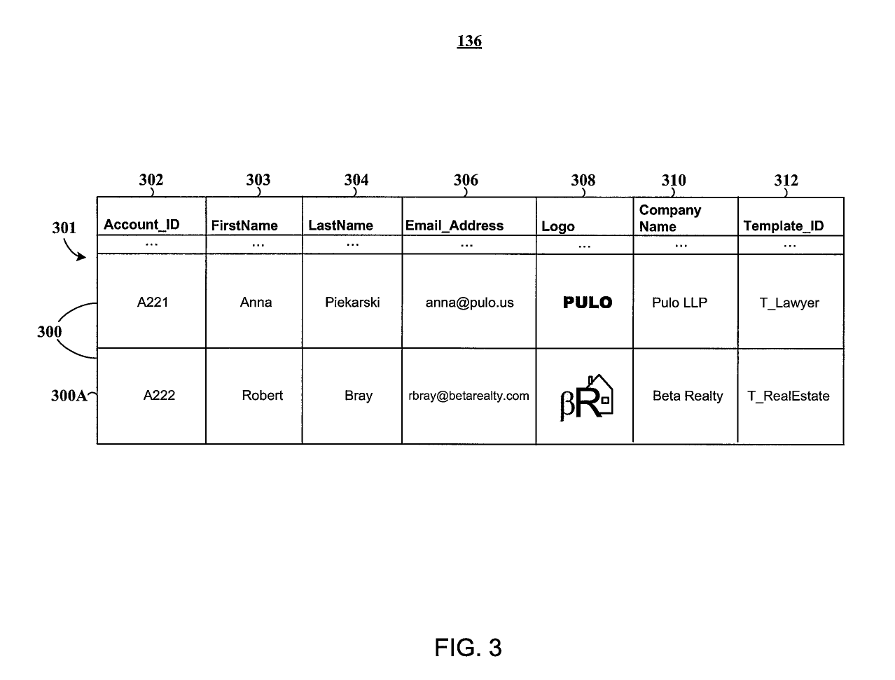

Referring now to FIG. 3, depicted therein is a schematic illustration of example customization records 300 containing exemplary customization data 301 as may be stored in the customization database 136. A specific customization record 300 in the customization data 301 will be merged with a customizable website template 146 to create a customized website 150.

The customization data 301 in the customization database 136 used to create a customized website 150 may be determined or otherwise obtained from a number of sources. In some embodiments, the customization data 301 may correspond to a subset of the customer information or customer data 201 (including modifications to such data) contained within the customer database 134. As shown in FIG. 3, customization data 301 may include an account identifier 302 (corresponding to account identifier 202) and other customer information such as a first name 303, a last name 304, an email address 306, and a company name 310. Media objects may also be stored in the customization database 136, such as a logo 308.

An expressions list 628 may be supplied by the website preprocessor 120 to enable the website hosting service 132 to determine the customization record 300. The website hosting service 132 may be configured to determine the customization record 300 corresponding to the expressions list 628 by matching the free-variable expressions 148 stored in the expressions list 628 with customer information stored in a customer record 200. Furthermore, it may be determined that some customer data fields may not be useful in creating a customized website 150 (such as the number of business cards 234 or the quality of the paper 236 in the business card printing example) and may be excluded from the customization record 300.

In other embodiments, the customization record 300 may be extracted from other sources, such as employee databases, vendor and purchaser databases (not shown), or other sources of information available to the website hosting system 130. Furthermore, the customization record 300 may be aggregated from multiple sources.

In at least one embodiment, the customization record 300 may be extracted from an existing website. An interface may be provided (not shown) that allows a user to match or otherwise connect content from an existing website to one or more free-variable expressions 148 positioned within the customizable website template 146. Furthermore, the website hosting service 132 may look to the underlying mark-up language of the existing website and extract data corresponding to certain content directly. For example, referring briefly to FIG. 10B, the website hosting service 132 may be configured to match the free-variable expression 148 labeled ---sitetitle---, with the <title> identifier available in a web page's underlying mark-up language and use this information to determine the matching or otherwise corresponding customization information to store in the customization record 300. Where supplied by the website preprocessor 120, an expressions list 628 may indicate the mark-up language identifiers which match or otherwise correspond to the free-variable expressions 148 positioned in a given customizable website template 146.

In some embodiments, a customization record 300 may also store template information. A template identifier 312 may correspond to a customizable website template 146 and may be used by the website preprocessor 120 to indicate which customizable website template 146 to use to create the customization website 150. Determining the template identifier 312 (and therefore, which customizable website template 146 is to be used) will be discussed further below.

Finally, while the customization data 301 is illustrated as being substantially uniform from one customization record 300 to the next, it should be understood that in some embodiments, each customization record 300 may have its own fields and its own structure.

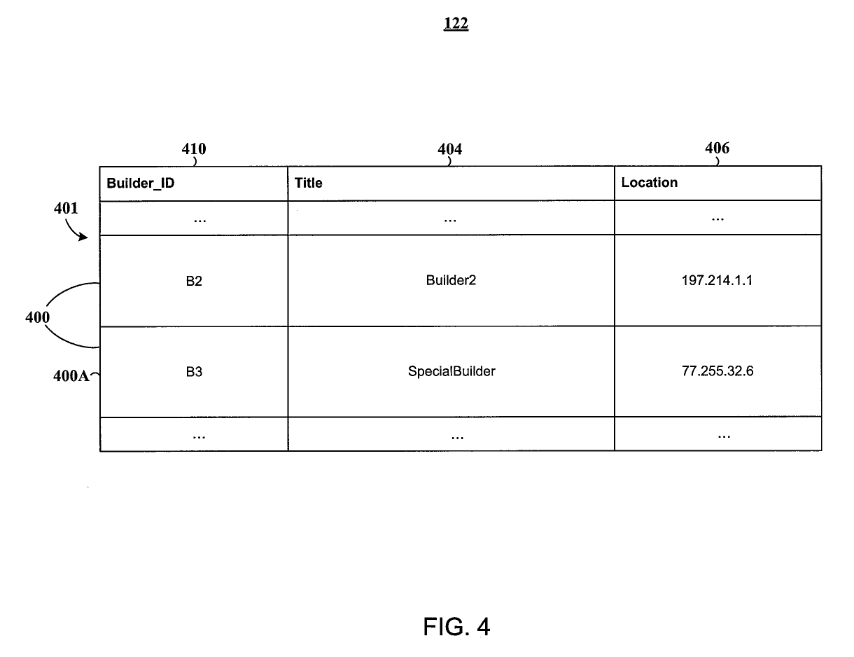

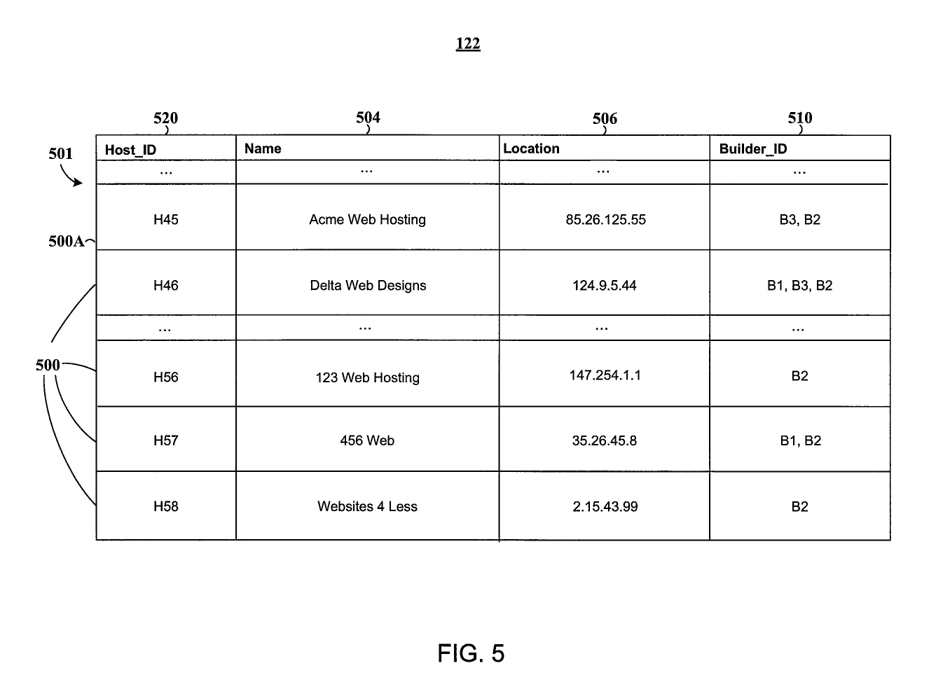

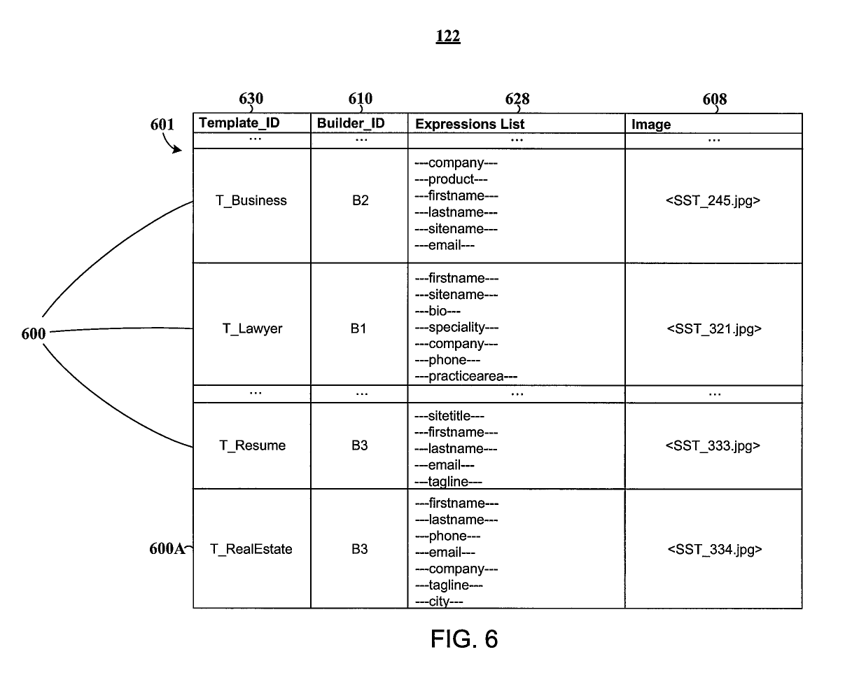

Referring now to FIG. 4, FIG. 5, and FIG. 6, the preprocessor registry 122 within preprocessing system 110 may include website builder identification records 400, host identification records 500, and template identification records 600. These records 400, 500, 600 are configured to enable the preprocessing system 110 to interface to the customization database 136 and the website builder database 144 by way of the website hosting service 132 and website builder application 142, respectively. As mentioned, the data structures are provided for exemplary purposes only and should not be construed as limiting.

Depicted in FIG. 4 is a schematic illustration of example website builder identification records 400 containing exemplary website builder identification data 401 as may be stored in the preprocessor registry 122. Each website builder identification record 400 may correspond to a website builder system 140 that the website preprocessor 120 of preprocessing system 110 is configured to operate with. Examples of website builder applications 142 known in the art are Trellix® Web Express, owned by Trellix Corporation, a subsidiary of Web.com, and CM4all WebsiteCreator, owned by Content Management AG. Referring to an exemplary record, the website builder identification record 400 may include a unique builder identifier 410. In configurations in which the preprocessing system 110 is configured to operate with more than one website builder system 140, the builder identifier 410 may allow the website preprocessor 120 to determine which website builder system 140 is to be employed for retrieving and storing the customized website 150.

Other builder information may also be stored in the website builder identification data 401. In some embodiments, a website builder identification record 400 may store the title 404 of the website builder application. This title 404 may be provided to a website hosting service 132, upon request. Importantly, the website builder identification record 400 may also store the location 406 of the website builder application 142 (such as its IP address). While the location 406 of the website builder application 142 is stored as a single field, it should be apparent that additional information may also be stored along with the location 406 to enable the website preprocessor 120 to communicate with the website builder application 142 over the network 180. Such additional information may include authentication information and encryption information (not shown).

Referring now to FIG. 5, depicted therein is a schematic illustration of example host identification records 500 containing exemplary host identification data 501 as may be stored in the preprocessor registry 122. Each host identification record 500 may correspond to a website hosting system 130 that the website preprocessor 120 of preprocessing system 110 is configured to operate with. For example, a host identification record 500 may contain a unique host identifier 520 to identify each of the different website hosting systems 130. Furthermore, it may contain other identifying information such as the name of website hosting system 504 and its location 506, such as by Internet Protocol address (IP address). As with the registered builder websites data 301, persons skilled in the art will understand that any appropriate method for identifying the location 506 of the website hosting application 132 (or the location 406 of the website builder application 142) may be utilized. Furthermore, where an IP address is utilized, the records 400, 500 may contain either the Internet Protocol Version 4 (IPv4) address or the next generation Internet Protocol Version 6 (IPv6) address.

A website hosting service 132 may also be configured to operate with more than one website builder application 142. This may occur if the website preprocessing system 110 is configured to operate with multiple website builder systems 140. A builder identifier 510 in the host identification record 500 may then indicate that multiple website builder applications 142 are enabled for the particular website hosting service 132. For example, the builder identifier 510 in host identification record 500A indicates that Acme Web Hosting 504 is operable with two website builder applications 142. The website preprocessor 120 may match the builder identifier 510 in the host identification record 500A with the builder identifiers 410 in the website builder identification data 401. By matching builder identifiers 410, 510, the website preprocessor 120 may, in turn, determine the respective builder title 404 and location 406 for the builder identifiers 410 from a host identification record 500.

Referring now to FIG. 6, depicted therein is a schematic illustration of example template identification records 600 containing exemplary template identification data 601 as may be stored in the preprocessor registry 122. The template data 601 may include a unique template identifier 630 for identifying a customizable website template 146 in the website builder database 144. Each template identification record 600 may also contain a builder identifier 610 to identify the website builder database 144 that the customizable website template 146 is stored in. Furthermore, the builder identifier 610 may be used by the website preprocessor 120 to locate the website builder application 142 using the corresponding website builder identification record 400. As explained above for an exemplary host identification record 500A, the website preprocessor 120 may be configured to determine the location of a customizable website template 146 by matching builder identifiers 610, 410. Accordingly, the template identifier 630 allows the website preprocessor 120 to communicate with the website builder application 142 using its location 406 obtained from the corresponding website builder identification record 400 and to retrieve the customizable website template 146.

In some embodiments, the template identification data 601 may include fields that may be provided by the website preprocessor 120 to the website hosting service 132, such as an image 608 of the customizable website template 146 (or additional descriptive information). The website hosting service may use this provided information (i.e. image 608) to receive input from a customer on which customizable website template 146 to use to create the customized website 150. For example, a website hosting service 132 may display an array of template images 608 taken from the template identification data 601 to enable a customer to choose from a selection of customizable website templates 146. Any other suitable information may be stored in template identification data 601 for this purpose.

In some embodiments, the template identification record 600 may also include an expressions list 628. The expressions list 628 comprises a list of free-variable expressions 148 positioned in a particular customizable website template 146. It may be created during the creation of a customizable website template 146, as will be discussed later and may also be provided to the website hosting service 132. The expressions list 628 may be used by the website hosting service 132 to determine the customization data 301.

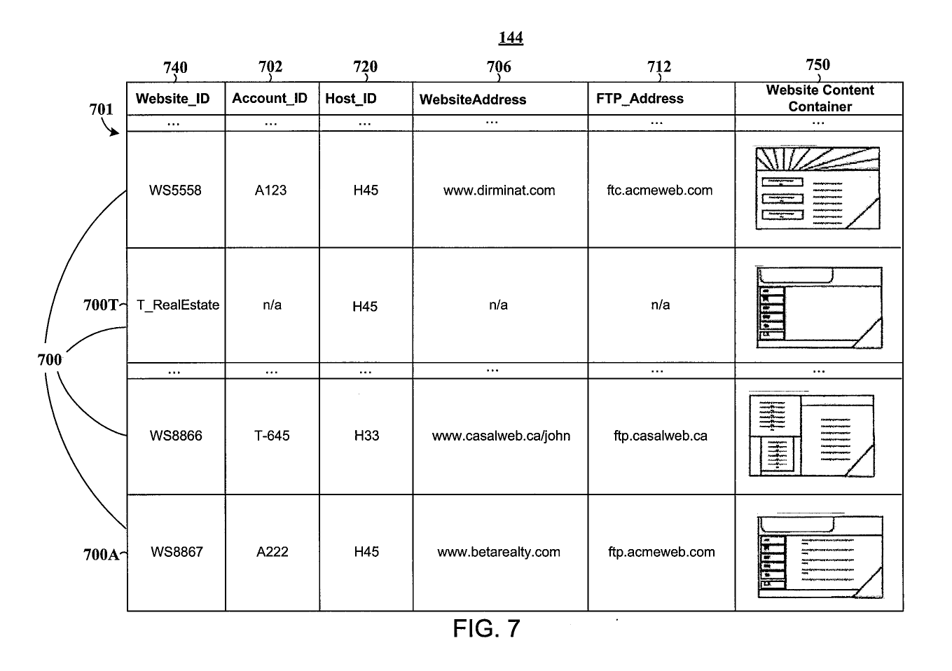

Referring now to FIG. 7, depicted therein is a schematic illustration of example registered builder website records 700 containing exemplary registered builder website data 701 as may be stored in a website builder database 144. Registered builder website record 700 may itself be considered a registered builder website 700. The registered builder website 700 may include data fields 740, 702, 720, 706, 712 necessary for the registered builder website 700 to function, along with the website information stored in the website content container 750. Although illustrated in FIG. 7 as a screen shot of a representative web page, it should be apparent to persons skilled in the art that the website content container 750 includes all the files and folders necessary to implement a registered builder website 700. This may include the appropriate folder structure, cascading style sheets (CSS), and website formatting. It should also be apparent to skilled persons in the art that the website content container 750 may include data objects such as images, media, and text.

A registered builder website record 700 may include a unique website identifier 740. This website identifier 740 may allow the website builder application 142 or the website preprocessor 120 to identify specific registered builder websites 700 stored within the website builder database 144. In addition, each record 700 may include an account identifier 702, which may correspond to the account identifier 202 passed from the website hosting service 132 via the website preprocessor 120 upon creation of the registered builder website record 700. The record 700 may also include host identifier 720, which may correspond to the host identifier 520 passed from the website preprocessor 120 upon creation of the registered builder website record 700. In some embodiments the registered builder website data 701 may simply store the values of the identifiers 702, 720. In other embodiments, the website builder system 140 may store information necessary to interface with a specific account 702 or a specific website hosting system 720. Such information may include the location of the account or website hosting system 130 on the network 180 or the website address 706. It may also include information necessary to communicate with website hosting system 130 such as authentication parameters and encryption settings. Finally, a registered builder website record 700 may also include an address for an ftp server 712, usernames (not shown), and passwords (not shown) for publishing the registered builder websites 700 to the appropriate website hosting system 130.

In some embodiments, the registered builder website 700 may be stored in one of a number of extensible markup languages, such as the Extensible Markup Language format (XML format) or HyperText Markup Language format (HTML format). As such, the website data may comprise a single web page. For example, the registered builder website record 700B in FIG. 7, may correspond to a single page website of the domain, www.casalweb.ca. In other embodiments, the registered builder website 700 stored in the website content container 750 may comprise a number of linked web pages. Further, in some embodiments, the website content container 750 of a registered builder website 700 may point to a second database (not shown) where additional contents of the registered builder website 700 are stored.

Reference will now be made to FIG. 2 through FIG. 12B in order to facilitate the description of a method for creating the customized website 150 as may be performed by the customized website creation system of FIG. 1. To more clearly illustrate the operation of the customized website creation system 100 in the context of creating a customized website 150, two exemplary use cases (an exemplary business card website and an exemplary domain name registrar) will be discussed to show the interaction between the preprocessing system 110, the website hosting system 130 and the website builder system 140.

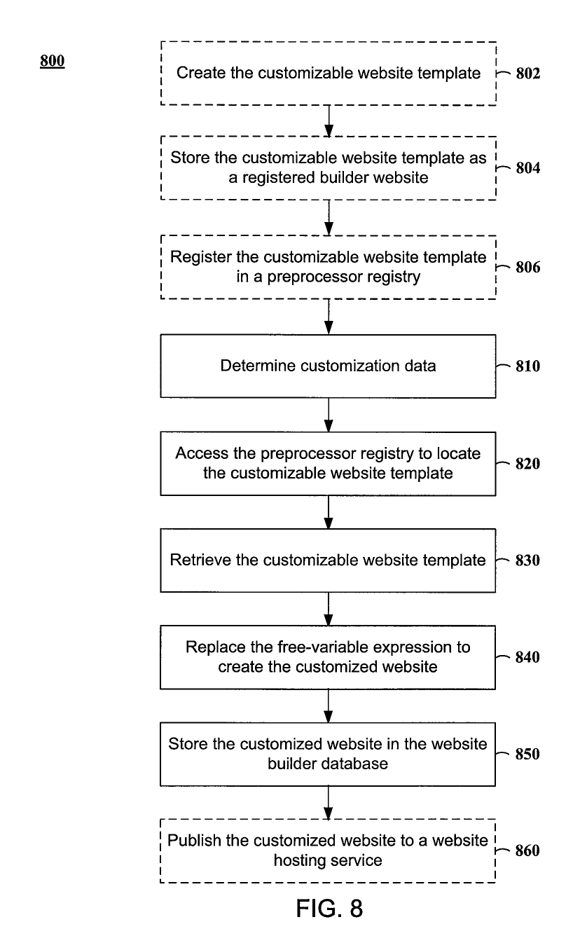

Referring first to FIG. 8, a flowchart illustrating the steps of a method for creating a customized website 150, in accordance with at least one embodiment, is shown generally as 800. Some steps of the illustrated embodiment, which may optionally be performed and/or performed at different times, are denoted using dashed blocks.

Starting at Block 810, customization data 301 is determined. As discussed, the customization data 301 may be stored in the customization database 136 as part of the website hosting system 130. The customization data 301 may be determined and/or provided to the website hosting system 130 as part of other services. For example, the customization data 301 may be selected from or otherwise determined to correspond to the customer data 201 stored in the customer database 134.

Generally speaking, a specific customization record 300 in the customization data 301 is used by the website preprocessor 120 to create the customized website 150 by replacing the free-variable expression(s) 148 within the customizable website template 146 with corresponding data from the customization record 300. To decide which customization information to include in the customization record 300 (such as the first name 212 or the company 224), the website hosting service 132 may need to first determine which customizable website template 146 to use and which free-variable expressions 148 are present in the corresponding customizable website template 146.

To determine which customizable website template 146 to use, the website hosting service 132 may receive instructions from the customer. The customer may indicate his or her preference through a customer computer 160 while interfacing with the website hosting system 130 (e.g., while purchasing business cards or registering a domain name). This choice, for example, from template images 608 or other descriptive information, may be stored in the customization record 300 as the template identifier 312. In some instances, the selection of customizable website templates 146 displayed to a user may be from a subset of customizable website templates 146 related to a specific target market or other subgroup to limit the number of choices to a reasonable selection.

Alternatively and in some embodiments, the website hosting service 132 may be configured to look to a specific customer information stored in the customer record 200 to determine which customizable website template 146 to use. For example, customer information in an exemplary customer record 200A refers to a real estate theme 222. The website hosting service 132 may use this theme 222 (or other indicative information) to determine that the customized website 150 to be created should be a real estate website and may choose a customizable website template 146 accordingly.

The website hosting service 132 may need to know which free-variable expressions 148 are located in the selected customizable website template 146 to determine the customization information for the customization record 300. If the website hosting service 132 has created the selected customizable website template 146, the website hosting service 132 may already know what customization information to include in the customization record 300. Alternatively, for a particular customizable website template 146, the free-variable expression(s) 148 may be manually inputted into the website hosting service 132 to enable the website hosting service 132 to determine what customization information to include in the customization record 300. Once determined, the customization record 300 stored in the customization data 301 may be sent to the website preprocessor 120.

In other embodiments, the website hosting service 132, may look to information received from the website preprocessor 120 to determine the customization information dynamically. For example, the website preprocessor 120 may supply an expressions list 628 to the website hosting service 132, to aid the website hosting service 132 in determining what customization information to include in a customization record 300. This expressions list 628 may be stored with the template identification record 600 and may be accessed and provided to the website hosting service 132 as part of the customizable website template selection 146 process. The website hosting service 132 may be configured to determine if a free-variable expression 148 contained within the expressions list 628 matches or otherwise corresponds to customer information stored in the corresponding customer record 200. For example, the website hosting service 132 may be configured to compare each of the free variable expressions 148 (i.e., ---firstname---, ---lastname---, ---company---) with names of each of the customer fields (e.g., 212, 214, 216, 224) in a customer record 200. Where a match is found, the correspondence and/or correlation will be noted and those matching fields of the customer record 200 will be included in the customization record 300 to be sent to the website preprocessor 120.

In some embodiments, this correlation between free-variable expressions 148 and customer fields (e.g., 212 to ---firstname---, 214 to ---lastname---) may be maintained in one or more correlation lists (not shown), matching a specific customer information field (e.g., 212, 214, 224) to a corresponding free-variable expression 148 utilized by a customizable website template 146. This list may be stored with the website hosting service 132 and/or the website preprocessor 120 and referenced when determining a new customization record 300. Updating this list may be undertaken manually by an operator as part of the website hosting system 130. This manual process may be updated each time a new customizable website template 146 becomes available to the website hosting service 132. Alternatively, the website hosting service 132 or website preprocessor 120 may be programmed to create and/or update such a correlation list using known keyword matching algorithms. Consequently, the website hosting service 132 may determine what customer information to include in the corresponding customization record 300 by referencing this correlation list.

Once the website hosting service 132 has determined a correlation between the customer information in the customer record 200 and each of the free-variable expressions 146 positioned in a customizable website template 146, as explained above, the website hosting service may select such correlated customer data 201 or otherwise determine the corresponding customization information. The website hosting service may create a customization record 300 using the corresponding customization information and send the customization record 300 to the website preprocessor 120.

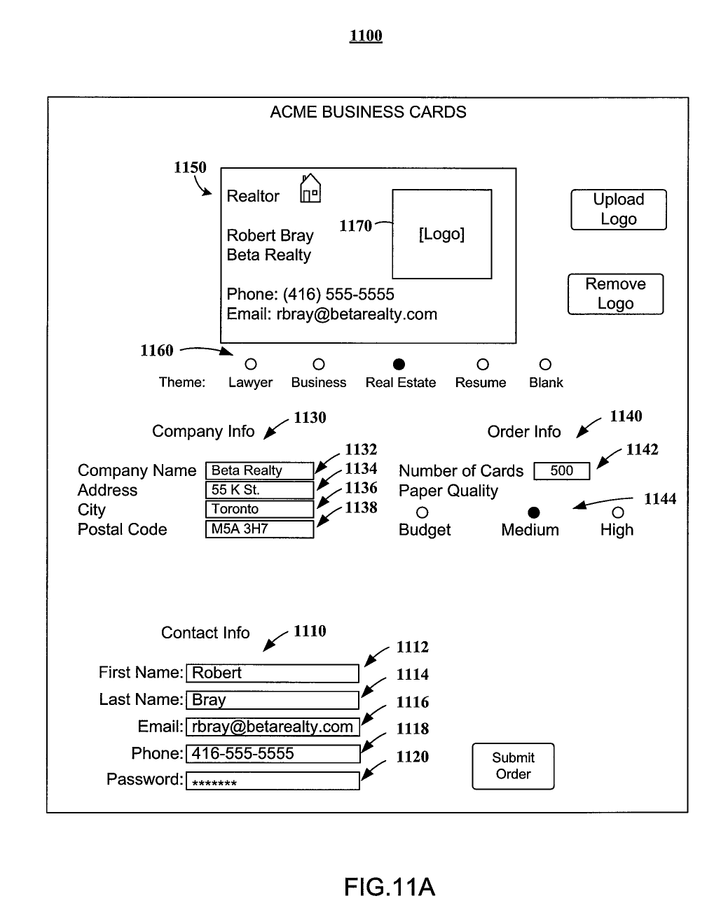

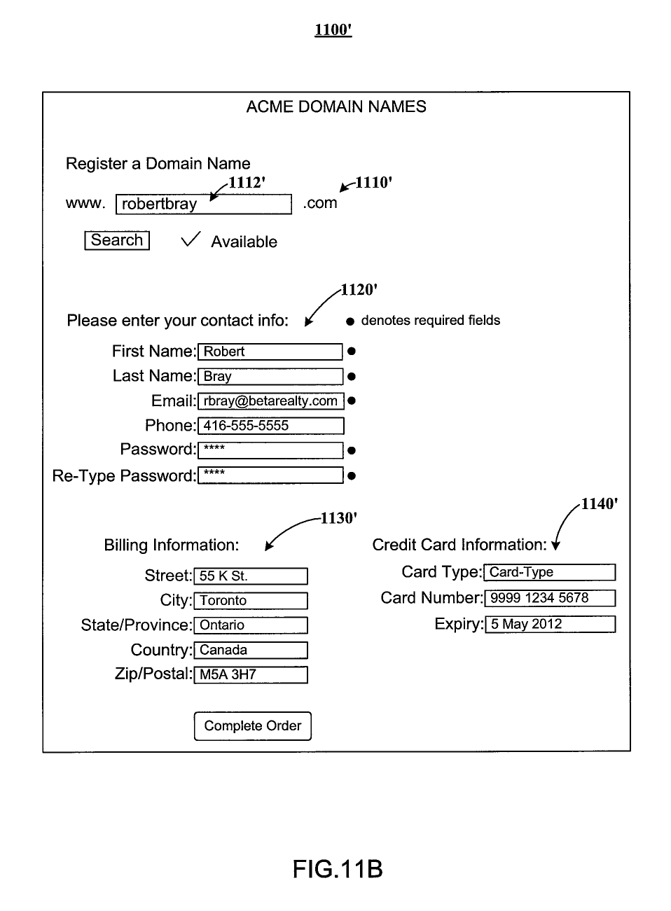

Referring now to FIG. 11A, there is illustrated a screen shot 1100 of a business card website coupled to the website hosting service 132 in one example implementation. This screenshot 1100 will illustrate how a customer record 200 containing customer data 201 and a corresponding customization record 300 containing customization data 301 may be determined according to some embodiments.

In FIG. 11A, the exemplary website hosting service 132 is configured to sell business cards to Internet users (e.g., through a networked customer computer 160). When the customer orders business cards, the customer may enter information for contact information 1110, company information 1130, and other order information 1140. While necessary for the ordering of business cards, this information may also be used by the customized website creation system 100 to create a customized website 150.

In the exemplary business card printing website of FIG. 11A, the website includes a mock-up 1150 of what the business card will look like. Theme field 1160 shown underneath the mock-up 1150 may indicate a particular formatting relationship for thematic business cards, including background images and the size, placement and formatting of the text. In this particular example, the business card website 1100 displays the information it has collected on a business card mock-up 1150 related to a realtor theme. The formatting may be different for business cards related to other themes. The business card mock-up 1150 may also have space for a logo 1170, which may include an image. The information entered by a customer to purchase business cards, in this example, may be entered into the customer database 134.

Referring now to FIG. 2, a customer record 200A may be created, storing the customer data 201 corresponding to the customer information that was submitted to purchase the business cards. For the business card example in FIG. 11A, exemplary data fields for contact information 1110 may include: a first name 1112, a last name 1114, an email 1116, a phone number 1118, and a password 1120. Exemplary data fields for company information 1130 may include: a company name 1132, an address 1134, a city 1136, and a postal code 1138. Finally, the order information 1140 may include the number of cards 1142, the paper quality 1144, the theme 1160, and a logo 1170. This information is stored in the customer record 200A (not all customer information is shown).

To determine the customization data 301, and specifically, to create a customization record 300 to send to the website preprocessor 120, the website hosting service 132 chooses a customizable website template 146 and determines what customer information to include in the customization record 300, using one of the embodiments described above. In this exemplary case, the user has chosen the customizable website template 1010 illustrated in FIG. 10A, which corresponds to the template identification record 600A, labeled “T_RealEstate”. This choice may be saved in the customization record 300A as the template identifier 312.

To determine the customization information to include in the customization record, the website hosting service 132 may have received the expressions list 628 for the template identification record 600A from the website preprocessor 120 as part of the selection process. The website hosting service 132 may be configured to determine the customization record 300A from the corresponding customer record 200A using the free variable expressions 148 listed in the expressions list 628, as described above. The customer information that matches or otherwise corresponds to the free-variable expressions (i.e., ---firstname--- with FirstName 212, ---company--- with Company Name 224) may be converted into customization information and be stored by the website hosting service 132 in the customization record 300A.

Reference is now briefly made to FIG. 11B, where there is illustrated a screen shot 1100′ of a second exemplary business format. The website hosting service 130 in FIG. 11B is related to a domain registrar. The website hosting service 132 is configured to sell domain names to Internet users (e.g., through a networked customer computer 160). In the example screen shot 1100′, the website hosting service 132 collects information necessary to sell (and register) domain names. This information may include domain name registration information 1110′, such as the desired domain name 1112′, contact information 1120′, billing information 1130′, and credit card information 1140′.

In this example, the customizable website template 1010′ in FIG. 10B may be the default customizable website template 146 for this particular website hosting service 132. The free-variable expressions 148 positioned in the customizable website template 1010′ may be known to the website hosting service 132, with no matching or correlation of the free-variable expressions 148 necessary. The website hosting service may create the corresponding customization record 300 with the customer information it has collected related to the known resume theme, including the default template identifier 312.

Once the customization record 300 has been created for a particular customizable website template 146, the customization record 300 may be sent to the website preprocessor 120 to make a customized website 150.

At Block 820 the preprocessor registry 122 is accessed to determine the location of the customizable website template 146 stored in the website builder database 144. The website preprocessor 120 is configured to start this determination by accessing the customization record 300 and retrieving the template identifier 312. Once the website preprocessor 120 is provided a customizable website template 146 to search for, it can refer to its database records 400, 600 to determine where the customizable website 146 is located.

Using the template identifier 312 provided in the customization record 300, the website preprocessor 120 may be programmed to search for the matching template identifier 630 in the template identification data 601 as seen in FIG. 6. A match indicates that the website preprocessor 120 recognizes the template identifier 312 as a customizable website template 146 it is familiar with. Once found, the website preprocessor determines which website builder database 144 the customizable website template 146 is stored in (based on the template identifier 312, 630). Reference to the website builder database 144 is stored in a template identification record 600 as the builder identifier 610. The website preprocessor 120 is then configured to find the website builder database 144 identified in the template identification records 600 by matching the desired builder identifier 610 with the matching builder identifier 410 in the website builder identification records 400 of FIG. 4. Finally, website preprocessor 120 is programmed to determine the location of the website builder database, 144 by accessing the location information 406 stored in the matching website builder identification record 400.

By way of example, in customization record 300A related to customer record 200A for the business card printing example discussed in Block 810, the website preprocessor accesses the template identifier 312, which identifies the desired customizable website template 146 as “T_RealEstate”. This information is located within the customization record 300A and was passed to the website preprocessor 120 over the network 180.

Next, the website preprocessor 120 determines the location of the customizable website template 146 (referenced as “T_RealEstate” by template identifier 312) by referencing the database records 400, 600 in the preprocessor registry 122. First, as described above, the website preprocessor 120 is configured to look to the template identification records 600 to find a matching template identifier 630. Finding template identification record 600A, the website preprocessor 120 looks to the builder identifier 610 and determines it must find the website builder database 144 referenced as “B3”. Referencing the website builder identification records 400, the website preprocessor 120 is then able to search the builder identifiers 410 to find a website builder database 144 matching the builder identifiers 410, 610, labeled as “B3”. Finally, accessing the matching website builder identification record 400A, the website preprocessor is able to determine the location 406 of the website builder database 144 (and hence the location 406 of the customizable website template 146, labeled “T_RealEstate”). According to the website builder identification record 400A, the website preprocessor 120 is able to determine that the location 406 of the website builder database 144, labeled “B3”, is at a specific IP address (“77.255.32.6”).

For the domain name registrar example referred to in Block 810 and illustrated in FIG. 11B, accessing the preprocessor registry to determine the location of the customizable website template 1010′ may be much simpler. As the desired customizable website template 1010′ is the only template available to the website hosting service 132, the website preprocessor may not need to search through multiple database records 400, 600 to determine its location. Instead, the website preprocessor may only need to read from memory where the default customizable website template 1010′ is stored. Once located, the customizable website template 146 may be retrieved.

At Block 830, the website preprocessor 120 is programmed to retrieve the customizable website template 146 from the website builder database 144 as determined in Block 820. The website preprocessor 120 may communicate with the website builder application 142 to retrieve the customizable website template 146. The website preprocessor 120 may request from the appropriate website builder application 142, the customizable website template 146 referenced by the template identifier 312, 630. The website builder application may then be configured to search the website identifiers 740 in the registered builder website data 701, for the particular template identifier 312, 630 provided by the website preprocessor 120. Once found, the website builder application 142 may return the registered builder website record 700 (and hence the appropriate customizable website template 146 including website content container 750) to the website preprocessor 120.

The retrieval of the customizable website template 146 from the website builder database 144 is specific to the website builder application 142. In some embodiments, the website builder application 142 may return the corresponding registered builder website record 700 as part of a function call. In other embodiments, the website preprocessor 120 may have access to the website builder database 144 itself. It should be understood that other embodiments may allow for different methods of retrieving the customizable website template 146, stored as a registered builder website record 700 from the website builder database 144. Finally, the customizable website template 146 may then be copied into temporary storage (not shown), such as random access memory (RAM) or system cache, within preprocessing system 110.

Referring once again to the business card example described in Block 810, the website preprocessor 120 may have determined the location of the customized website template 1010 in Block 820. By accessing the database records 400A, 600A stored in the preprocessor registry 122 and referencing the template identifier 312 provided in the customization record 300A, the website preprocessor 120 may have identified the template identifier 312 as a corresponding registered builder website record 700T stored in a particular website builder database 144 (see FIG. 7). The website preprocessor 120 may then be configured to retrieve the customizable website template 1010 by making an appropriate request to the website builder application 142. Accordingly, the website builder application 142 may search the registered builder website data 701 and return the requested registered builder website record 700T to the website preprocessor 120.

Similarly, in the domain name registrar example described in Block 810, the website preprocessor 120 may have determined the location of the default customizable website template 1010′ by reading its location from the preprocessor registry 122, as explained in Block 820. The website preprocessor 120, in this example, may then make a similar request to the website builder application 142 to retrieve the customizable website template 1010′. Once retrieved from the website builder database 144, the customizable website template 1010 may be stored temporarily by the website preprocessor 120 for free-variable expression replacement.

At Block 840, the customizable website template 146 retrieved from the registered builder website data 701 is stored temporarily by the website preprocessor 120. The free-variable expression 148 positioned within the customizable website template 146 is then replaced with the information stored within the corresponding customization record 300 to create the customized website 150. As noted above, there may be more than one free-variable expression 148 positioned within the customizable website template 146 to replace. Similarly, there may be multiple instances of a particular free-variable expression 148 that will be replaced by the website preprocessor 120.

The website preprocessor 120 may search the entire customizable website template 146 (i.e. registered builder website record 700) for every free-variable expression 148. As discussed above, the free-variable expressions 148 may consist of a delimiter attached to a reference name. In the examples illustrated herein, the free-variable expressions 148 consist of beginning and ending delimiters of “---” sandwiching a reference name or descriptor. Other formatting is possible. The free variable expressions 148 are designed to be easily identified by the website preprocessor 120. When a free variable expression 148 is found, the website preprocessor 120 will determine if there is a corresponding piece of customization information in the customization record 300. If a match is found (e.g. ---company--- and Company Name), the free-variable expression 148 may be replaced with the corresponding customization information found within the customization field (e.g., 310 for “Company Name”). Where there is no customization data 301 for a particular free-variable expression 148, the website preprocessor 120 will take appropriate action, which may include leaving the free-variable expression 148 in place in the customized website 150 for manual replacement.

Referring once again to the business card example from Block 810, the determined customization information from FIG. 11A is stored in the customization record 300A and the customizable website template 700T (i.e., 1010 from FIG. 10A) has been retrieved by the website preprocessor 120. The website preprocessor may now replace the free-variable expressions 148 positioned within the customizable website template 1010. To replace the free-variable expressions 148, the website preprocessor 120 searches the customizable website template 1010 for each of the free-variable expressions 148 and replaces them with the corresponding customization information in customization record 300A, using one of the correlation methods described above. For example, the website preprocessor 120 may replace the free-variable expression 148, depicted as “---company---”, with “Beta Realty”, which is stored in the customization record 300A as corresponding customization field 310, “Company Name”. Similarly, the free-variable expressions 148, depicted as “---firstname---” and “---email---”, are replaced with “Robert” and “rbray@betarealty.com”, respectively found in the corresponding customization fields 302, 306. Free-variable expressions 148 relating to media objects may also be replaced by the website preprocessor 120. In the customizable website template 1010, the free-variable expression 148′, depicted as “---logo---”, is replaced with an image of the company logo 308, also stored within the customization record 300A.

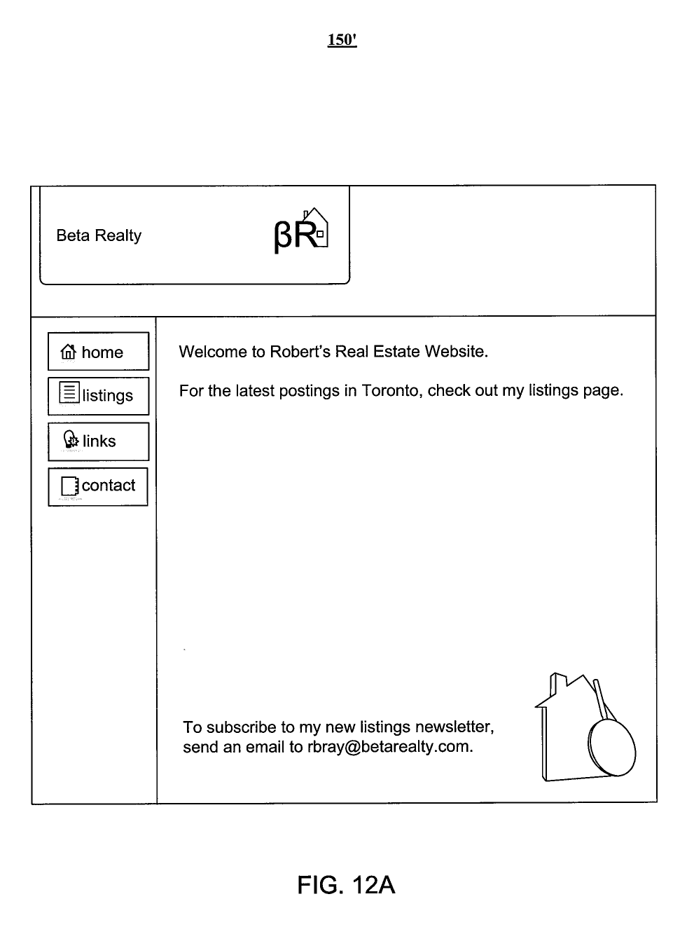

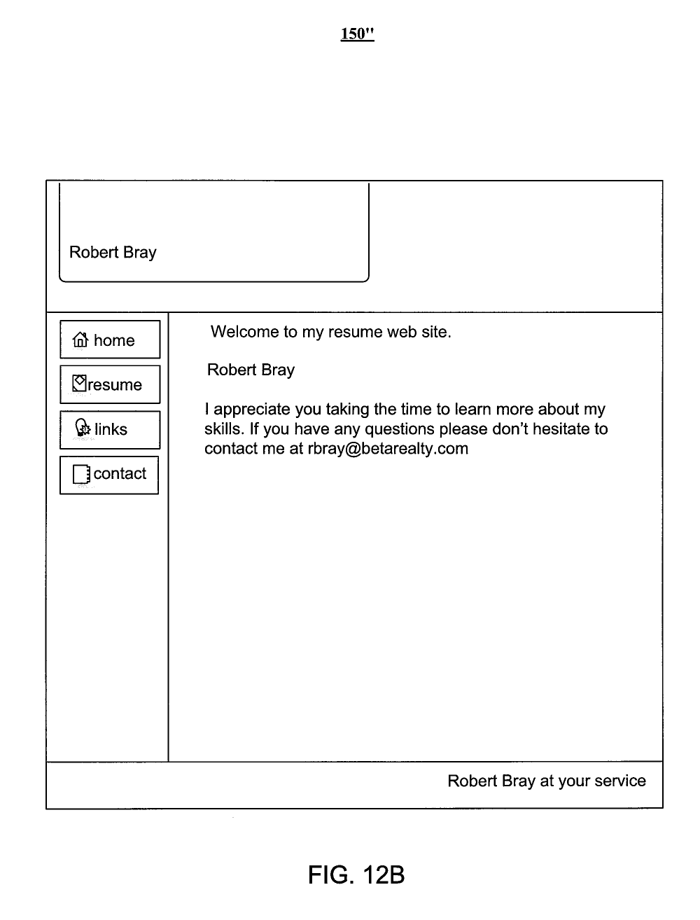

Referring now to FIG. 12A, a screen shot of the realized customized website 150′ is illustrated. The customized website 150′ incorporates the customer information gathered in relation to the business card website seen in FIG. 11A with the realtor-themed customizable website template 1010 illustrated in FIG. 10A and stored in the website builder database 144 as a registered builder website 700T. The free-variable expressions 148 in the customizable website template 1010 have been replaced with information from the customization record 300A stored in the customization database 136. The customization information is displayed as part of the customized website 150′. For example, “Beta Realty” and “Toronto” have replaced their corresponding free-variable expressions 148 in the customized website 150′. In addition, free-variable expression 148′ related to a logo has been replaced with the corresponding logo 308 stored in the customization record 300A.

Referencing once again, the domain name registrar example described in Block 810, the customization record 300 and the customizable website template 1010′ illustrated in FIG. 10B are now both located within the preprocessing system 110. The website preprocessor 120 may now be configured to replace the free variable expressions 148 positioned within the customizable website template 1010′ with the corresponding customization information from the customization record 300 related to customer information collected in registering a domain name in FIG. 11B. Once again, to replace the free-variable expressions 148, the website preprocessor 120 searches the customizable website template 1010′ for each of the free-variable expressions 148 and replaces them with the corresponding customization information to create the customized website 150″ seen in FIG. 12B.

Referring now to FIG. 12B, there is illustrated a screen shot of the customized website 150″ created from the resume-related customizable website template 1010′ seen in FIG. 10B incorporating the corresponding customer information from the domain registrar website seen in FIG. 11B. As in FIG. 12A, the free-variable expressions 148 have been replaced with the customization information stored in the customization record 300 obtained at the website hosting service 132 by the website preprocessor 120. For example, the free-variable expressions 148 labeled “---firstname---” and “---lastname---” illustrated in 1010′ have been replaced with “Robert” and “Bray” obtained from corresponding customization fields seen in the customer information collected from the domain name registrar site in FIG. 11B. The customized websites 150′, 150″ are now complete and may be stored or published.

At Block 850 the customized website 150 is stored in the website builder database 144. The website preprocessor 120 sends the customized website 150 to the website builder database 144 for storage. In some embodiments, the customized website 150 is stored in the website builder database 144 as a registered builder website 700. Accordingly, there may be no structural indication that the customized website 150 was derived from a customizable website template 146. From the perspective of the website builder system 140 and the website builder application 142, the customized website 150 is structured in a manner similar to other registered builder websites 700.

Referring now to FIG. 7, the customized website 150′ for the business card example seen in FIG. 12A is sent to the website builder application 142 for storage in the website builder database 144. The website builder application 142 may store the customized website 150 as a new registered builder website 700A. As part of creating a new registered builder website 700, the website builder application 142 may automatically generate a new website identifier 740 for the new registered builder website 700A. Once stored, the customized website 700A may be edited using the website builder application 142.

In some embodiments, the operation of the website preprocessor 120 with respect to a given customized website 150 may be complete once it has sent the customized website 150 to the website builder database 144 (or alternatively the website builder application 142) for storage. The website preprocessor 120 is no longer needed to interface with the customized website 150. Future modifications to the customized website 150 may be undertaken by the user utilizing the website builder application 142. Instead, the user may log in directly to the website builder application 142 or navigate its way to the website builder application 142 through the website hosting service 132. At this stage, the utility of the customization data 301 may now also be complete. While the customization records 300 are illustrated as being collected and stored beyond creation of a corresponding customized website 150, it should be understood that once a customized website 150 has been created in some implementations, the corresponding customization data 301 may be deleted.

At Block 860, the customized website 150 may be published to the website hosting system 130 using the website preprocessor 120. This may involve sending the customized website 150 to the website hosting service 132, which may store the customized website 150 on its web servers (not shown) and make the customized website 150 available to users over the Internet terminals 170, 170′. When the customized website 150 is posted by the website hosting service 132, the customized website 150 will be displayed. Furthermore, the customization information in the customization data 301 will also be displayed and shown as part of the realized customized website 150.

In some embodiments, the customized website 150 may not be stored in the website builder database 144 in the appropriate format for publishing. The website preprocessor 120 may first need to process the customized website 150 before posting to the website hosting service 132. For example, in some embodiments, the website builder application 132 stores the registered builder websites 700 in the Extensible Markup Language format (XML format). Some website hosting services 132 may not accept websites in this format. Instead, some website hosting services 132 may only publish websites in the HyperText Markup Language (HTML format). Accordingly, the website preprocessor 120 may need to convert the customized website 150 stored in the XML format to the HTML format prior to publishing. This may involve the website preprocessor 120 being configured to use conversion tools or conversion methods known to persons skilled in the art.

Referring again to FIG. 8, creating the customizable website template 146 and storing it in the website builder database 144 is referred to in Block 802, Block 804, and Block 806. These steps of the method 800 may be completed by a user of the website hosting system 130 as a separate process to creating a customized website 150. Alternatively and in some embodiments, these steps of the method may be completed by users of the website preprocessing system 110 as part of the initial setup of the customized website creation system 100.

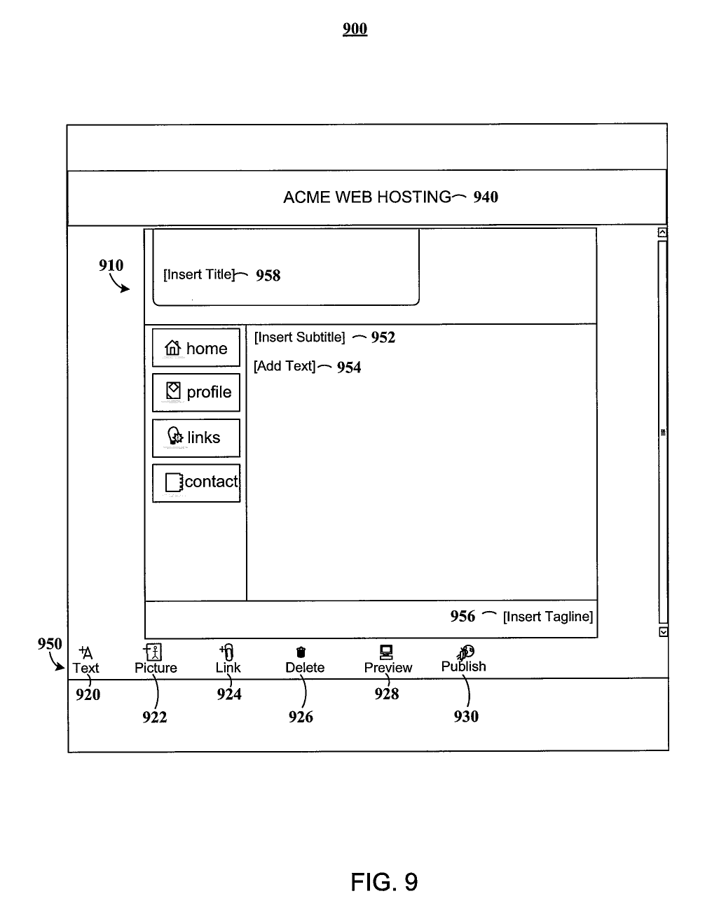

Referring now to FIG. 9, a blank template 910 is depicted inside an interface for a website builder application 142. A user may create the blank template 910 using the tools provided by the website builder application 142. The blank template 910 may also have been downloaded from an external source, such as a template source on the Internet or have been provided by the website builder system 140. If imported from outside the website builder application 142, certain parameters may have been configured to allow the blank template 910 to operate within the website builder system 140. Such steps may include arranging the folder structure of the builder website and modifying certain configuration files (not shown).

The interface illustrated by screen shot 900 may provide website builder tools 950 to allow a user to modify the text and format of the blank template 910. Specifically, tools may include the ability to: add text 920, add a picture 922, add a link 924, delete items 926, preview the site 928, and to publish the blank template 910 to the web 930. For example, the tools may be used to create text or modify the website design. The website builder application 142 may also be configured to include website builder interface branding 940 for a specific website hosting system 130.

A customizable website template 146 may be created from a blank template 910. Whereas customizable website templates 146 include at least one free-variable expression 148 positioned within the design, blank templates 910 do not have such features. Instead, a blank template 910 may simply have space located within the blank template 910 for text to be added 952, 954, 956, 958.

At Block 802, the customizable website template 146 is created using the website builder application 142. This may be accomplished using the tools provided by the website builder application 142 to modify the design of a blank template and to create some pre-generated content. Using the same website builder application 142 to create the customizable website template 1010 may ensure the integrity of the file structure for reliable operation of the customized website 150 during future modifications.

Referring now to FIG. 10A, there is illustrated a screen shot 1000 of the customizable website template 1010 inside website builder system 140. The customizable website template 1010 corresponds to a realtor-themed website (such as might be used by a business card printing service). The customizable website template 1010 is based on the blank template 910 illustrated in FIG. 9. A user (not shown), such as the owner of a website hosting system 130, may add pre-generated content to a blank template 910. Furthermore, a free-variable expression 148 may be positioned within the customizable website template 1010. The free-variable expression 148 may be part of a website design and may be included using the tools provided by the website builder application 142 so as to be replaced by corresponding customization data 301. Furthermore, the customizable website template 146 may be tailored for a specific theme. For example, the customizable website template 1010 seen in FIG. 10A has specific pre-generated content added to the blank template 910 related to a real estate website. The free-variable expressions 148 may also be related to this theme.

Referring now to FIG. 10B, there is illustrated a screen shot 1000′ of another example customizable website template 1010′ related to a resume profile. As in FIG. 10A, the resume template may include content specific tailored to a particular theme. In this example, a profile page is depicted for a user to upload his or her resume. It includes pre-generated content about the website, including name and tagline, and content for how to contact the owner of the website. The resume template may also include free-variable expressions 148 in certain positions within the content for future replacement with customization data 301.

Once the customizable website template 146 is created using the website builder application 142, the customizable website template 146 is stored in the website builder database 144 at Block 804. If a website builder system 140 does not provide access to its template registry (not shown), it may be necessary to store the customizable website template 146 as a registered builder website record 700. Accordingly, there may be no structural indication that the customizable website 146 is any different than any other registered builder website 700. From the perspective of the website builder system 140 and the website builder application 142, the customizable website template 146 may be structured in a manner similar to other registered builder websites 700.

Referring now to FIG. 7, the customizable website template 1010 created in FIG. 10A, is saved as a registered builder website record 700T. The customizable website template 146 is sent to the website builder application 142 for storage and a new registered builder website record 700T is created. The design and pre-generated content, including free-variable expressions 148 will be stored in the website content container 750. In addition, other information, such as a host identifier 720 may be saved as part of the registered builder website record 700T. Furthermore, although the website identifier 740 for the new registered builder website 700T (i.e. the customizable website template 1010) is labeled “T_RealEstate”, this website identifier 740 should not be construed as limiting. In some embodiments, the website identifier 740 may follow an incremental numbering scheme or any appropriate naming convention.

At Block 806, the website preprocessor 120 registers the name and location of the customizable website template 146 in the preprocessor registry 122 by creating a new template identification record 600. Specifically, the template identifier 630 may reference the website identifier 740 for the customizable website template 146 stored as a registered builder website 700. Similarly, the location of the customizable website template 146 in website builder database 144 may be recorded by storing a builder identifier 610 referencing the appropriate website builder identification record 400. The website preprocessor 120 may then reference the location of the website builder database 144 through its location 406 stored in the website builder identification record 400 referenced by the common builder identifier 610, 410.

The website preprocessor 120 may also store an image 608 and an expressions list 628 for the customizable website template 146 in the template identification data 601. As described above, an expressions list 628 may include each of the free-variable expressions 148 positioned within the customizable website template 146 and may be used by the website preprocessor 120 to indicate to the website hosting service 132 what customization information to store in the customization record 300. The expressions list 628 may be created by the website preprocessor 120 by searching and then compiling a list of each free-variable expression 148 in the customizable website template 146. The website preprocessor 120 may then be configured to store the expressions list 628 in the new template identification record 600. Once referenced in the template identification data 601, the customizable website template 146 may be used to create a customized website 150.

FIG. 6 illustrates creating a new template identification record 600A for the example business card printing template 1010 illustrated in FIG. 10A. Once stored in a website builder database 144, the website preprocessor 120 may be configured to create a new template identification record 600A for the customizable website template 700T. The website preprocessor 120 may be configured to store the website identifier 740 (“T_RealEstate”) as the template identifier 630. The website preprocessor 120 may also be programmed to store the builder identifier 610 in the template identification record 600A. This identifier 610 (“B3”) enables the website preprocessor 120 to find the location 406 (“77.255.32.6”) of the website builder application 142 by matching the builder identifiers 610, 410 between the new template identification record 600A with its corresponding website builder identification record 400A. The website preprocessor 120 may also store the expressions list 628 and an image 608 for the real estate template 1010 in the template identification record 600A. As described above, the expressions list may be compiled by the website preprocessor 120 by searching the customized website template 1010 for the free-variable expressions 148. Once the new website template record has been added to the template identification data 601, customizable website template 700T, 1010 may be used by a website hosting service 132 (as described above) for creating a new customized website 150.

It should be understood that storing the customizable website template 146 as a registered builder website record 700 allows the preprocessing system 110 to operate with a greater number of website builder systems 140 and website builder applications 142. It should be appreciated that the website preprocessing system 110 is not dependent on a given website builder application 142 to provide mechanisms for adding customizable website templates 146 to its template registry (not shown). Instead, the customizable website template 146 may be stored as a registered builder website 700, and the preprocessing system 110 may be configured to store information specific to the customizable website template 146 and the two component systems 130, 140 or modules 132, 142, in the preprocessor registry 122. The website preprocessor 120 is configured to use this information to create the customized websites 150 with the customization data 301 incorporating the website hosting system 130 and the website builder system 140.

It will be understood by persons skilled in the art that the features of the user interfaces illustrated with reference to the example screenshots, templates, lists and layouts described herein are provided by way of example only. It will be understood by persons skilled in the art that variations are possible in variant implementations and embodiments.

The steps of a method in accordance with any of the embodiments described herein may be provided as executable software instructions stored on computer-readable media. Such steps may not be required to be performed in any particular order, whether or not such steps are described in claims or otherwise in numbered or lettered paragraphs.

The invention has been described with regard to a number of embodiments. However, it will be understood by persons skilled in the art that other modifications may be made without departing from the scope of the invention as defined in the claims appended hereto.

What is claimed is:

1. A system for creating a customized website, the system comprising:
(a) a customization database configured to store customization data;
(b) a website builder database configured to store a plurality of registered builder websites;
(c) a customizable website template comprising a free-variable expression positioned within the website template, wherein the customizable website template is stored in the website builder database as a registered builder website;
(d) a preprocessor registry configured to register the location of the customizable website template in the website builder database; and
(e) a website preprocessor operatively coupled to the preprocessor registry, wherein the website preprocessor is configured to:
(i) access the preprocessor registry to determine the location of the customizable website template;
(ii) retrieve the customizable website template from the website builder database;
(iii) replace the free-variable expression within the customizable website template with the customization data to create the customized website; and
(iv) store the customized website in the website builder database.

2. The system of claim 1, further comprising a website builder application operatively coupled to the website builder database, wherein the website builder application is configured to modify registered builder websites.

3. The system claim of 1, wherein the website preprocessor is further configured to publish the customized website to the website hosting service.

4. The system of claim 1, wherein the customization data is displayed when the customized website is displayed.

5. The system of claim 1, further comprising a customer database configured to store customer data, wherein the customization data corresponds to customer data.

6. The system of claim 5, further comprising a website hosting service operatively coupled to the customer database, wherein the website hosting service is configured to determine customer data.

7. The system of claim 6, wherein the website preprocessor is further configured to supply an expressions list comprising the free-variable expression, to the website hosting service.

8. The system of claim 7, wherein the website hosting service is further configured to determine the customization data in correspondence to the expressions list.

9. A preprocessing system for creating a customized website, the preprocessing system for use with:
(a) a customization database configured to store customization data;
(b) a website builder database configured to store a plurality of registered builder websites; and
(c) a customizable website template comprising a free-variable expression positioned within the website template, wherein the customizable website template is stored in the website builder database as a registered builder website;
wherein the preprocessing system comprises:
(d) a preprocessor registry configured to register the location of the customizable website template in the website builder database; and
(e) a website preprocessor operatively coupled to the preprocessor registry, wherein the website preprocessor is configured to:
(i) access the preprocessor registry to determine the location of the customizable website template;
(ii) retrieve the customizable website template from the website builder database;
(iii) replace the free-variable expression within the customizable website template with the customization data to create the customized website; and
(iv) store the customized website in the website builder database.

10. The preprocessing system of claim 9, wherein the website preprocessor is further configured to publish the customized website to a website hosting service.

11. The preprocessing system of claim 9, wherein the website preprocessor is further configured to supply an expressions list comprising the free-variable expression, to a website hosting service.

12. The preprocessing system of claim 11, wherein the website hosting service is further configured to determine the customization data in correspondence to the expressions list.

13. A method for creating a customized website, the method comprising:
(a) providing a customizable website template in a website builder database, wherein the customizable website template comprises a free-variable expression positioned within the customizable website template;
(b) determining customization data;
(c) accessing a preprocessor registry to determine the location of the customizable website template;
(d) retrieving the customizable website template from the website builder database;
(e) replacing the free-variable expression positioned within the customizable website template with the customization data to create the customized website; and
(f) storing the customized website in the website builder database.

14. The method of claim 13, further comprising publishing the customized website to a website hosting service.

15. The method of claim 13, wherein the customization data is displayed when the customized website is displayed.

16. The method of claim 13, wherein the customization data is determined to correspond to customer data stored in a customer database.

17. The method of claim 16, further comprising determining customer data at a website hosting service, wherein the website hosting service is operatively coupled to the customer database.

18. The method of claim 13, further comprising supplying an expressions list comprising the free-variable expression, to a website hosting service.

19. The method of claim 18, wherein determining the customization data comprises determining the customization data in correspondence to the expressions list.

20. A non-transitory computer readable storage medium storing program code which, when executed by a processor, causes the processor to perform the method of claim 13.
